(19) United States
(12) Patent Application Publication
(10) Pub. No.: US 2026/0035569 A1
(43) Pub. Date: Feb. 5, 2026

(54) INORGANIC COATING LIQUID, INORGANIC COATING FILM, AND DEVICE HAVING INORGANIC COATING FILM

(71) Applicant: COSMO TEC INC., Tokyo (JP)

(72) Inventors: Hisashi CHIGUSA, Tokyo (JP); Masataka YOSHIKAWA, Tokyo (JP); Takashi NISHIMURA, Saitama (JP); Masami HASHIMOTO, Aichi (JP)

(21) Appl. No.: 19/283,209

(22) Filed: Jul. 28, 2025

(30) Foreign Application Priority Data
Jul. 30, 2024 (JP) JP2024-124091

(51) Int. Cl. C09D 1/00; B05D 3/10; D06B 1/00; D06B 19/00; D06B 21/00

(52) U.S. Cl. CPC C09D 1/00; B05D 3/101; B05D 3/102; D06B 1/00; D06B 19/00; D06B 21/00; B05D 2201/02; B05D 2202/15; B05D 2202/30; D10B 2401/13

(57) ABSTRACT

The present invention provides a method for forming an inorganic coating film, the method including: forming irregularities having a thickness of 0.1 to 1.0 μm on a base material corroded by an acid or a base material having a surface chemically and/or physically changed by an acid, using an inorganic coating liquid containing a copper ion and phosphoric acid and having a pH value of 2.0 to 6.0, in which the inorganic coating film includes copper and phosphorus derived from the copper ion and phosphoric acid. Furthermore, the present invention provides an inorganic coating liquid used in such a method, an inorganic coating film formed by the method, and a device having the inorganic coating film.

### CROSS-REFERENCE TO RELATED APPLICATIONS

This application claims the benefit of priority under the Paris Convention to Japanese Patent Application No. 2024-124091, filed on Jul. 30, 2024. The contents of the Japanese application are hereby incorporated by reference in their entirety.

### BACKGROUND OF THE INVENTION

### 1. Technical Field

The present invention relates to an inorganic coating liquid to be applied to a base material, an inorganic coating film, and a device having an inorganic coating film.

### 2. Description of the Related Art

Since the COVID-19 outbreak, various antimicrobial/antiviral products have attracted attention. In particular, silver-based antimicrobial agents, copper-based antimicrobial agents, photocatalysts, and the like are commercially available as products.

Japanese Patent No. 5723097 discloses an antiviral coating material containing particles of at least one kind of a monovalent copper compound selected from the group consisting of CuCl, Cu(CH₃COO), CuI, CuBr, Cu₂S, CuCN, and CuSCN as an active ingredient that inactivates a virus, in which when a coating film is formed, the virus is inactivated by the particles of the monovalent copper compound exposed from a surface thereof.

Japanese Patent No. 7575285 (JP 2022-119552 A) discloses a polyolefin-based extruded resin foam having excellent foamability which contains a phosphate-based compound carrying silver, a silver compound, or silver ions in an amount of 0.8 to 5.0 parts by mass with respect to 100 parts by mass of a polyolefin resin.

Japanese Patent No. 7190265 discloses a coating agent containing at least two kinds of photocatalysts and a binder.

Japanese Patent No. 7602233 (JP 2023-072599 A) discloses an antiviral aqueous overcoat composition containing a binder component, a copper compound, and water.

JP 2024-001735 A discloses a wet-area member including a base material and a surface layer provided thereon, the wet-area member containing a (meth)acrylic resin, particles, and an inorganic antiviral agent.

Japanese Patent No. 6808489 (JP 2017-501150 A) describes an invention of an antimicrobial composition including an aqueous solution containing a copper salt, a basic ammonium salt added to the copper salt solution to form an insoluble copper-ammonium complex, and at least one water-soluble acid added to the copper salt solution to solubilize the copper-ammonium complex and adjust the pH of a clear blue acid-soluble copper-ammonium solution formed thereby. Examples of the water-soluble acid include phosphoric acid (claim 1). Japanese Patent No. 6808489 also describes that it can be made into a topical preparation such as an impregnated dressing which can be applied to working surfaces of houses, hospitals, factories, vehicles, and the like (paragraph 0025). Japanese Patent No. 6808489 further describes, as a specific example, an acid-soluble copper-ammonium complex composition or an acid-soluble copper-zinc composition containing 16.0 g of CuSO₄·5H₂O, 2.0 g of (NH₄)₂CO₃ or 2.0 to 3.2 mL of NH₄OH (10% solution), and 2.0 to 5.0 g of H₃PO₄ (Table 1: Cu #1, #3a, and #27, and Table 2: Cu—Zn #7 and #10).

Japanese Patent No. 5723097 is an invention in which a monovalent copper compound is exposed from a surface when a coating film is formed, and there is a description that a binder component may be added. Japanese Patent No. 7575285 is an invention of a foam containing an antimicrobial agent in a resin. In all of Japanese Patent No. 7190265, Japanese Patent No. 7602233, and JP 2024-001735 A, an inorganic antimicrobial/antiviral agent containing a binder component is applied to a base material and dried to bring the inorganic antimicrobial/antiviral agent into close contact with the base material via the binder, thereby maintaining the antimicrobial/antiviral performance.

However, the inorganic antimicrobial/antiviral agent has an effect of inactivating bacteria and viruses and suppressing proliferation of bacteria and viruses by bringing the bacteria and viruses into direct contact with inorganic ions and photocatalytic components. Therefore, in a case where a binder component is contained, the antimicrobial/antiviral performance tends to decrease as compared with the case where no binder component is contained.

Therefore, an antimicrobial/antiviral coating agent not containing a binder component is ideal, but when a binder is not contained, there are concerns that adhesion to a base material cannot be maintained and the antimicrobial/antiviral component may be easily peeled off by an action such as wiping a surface of the base material. Therefore, in any of the above patent documents, it is a problem to devise a binder and the like to maintain the performance for a long period of time.

In addition, since there are bacteria that generate odor components, the antimicrobial performance also has an effect of suppressing the odor generated by the bacteria.

Japanese Patent No. 6808489 also describes a topical preparation such as an impregnated dressing as an application, but this is merely one example of many listed applications such as a cream. In addition, Japanese Patent No. 6808489 describes only a topical preparation, and does not clearly describe a specific base material to which an antimicrobial composition is applied, and does not disclose a structural change such as forming irregularities on a surface by applying the composition to the base material. Therefore, the technique of Japanese Patent No. 6808489 only imparts temporary antibacterial properties to a target, and there remains a problem in adhesion to a base material and antibacterial performance over a long period of time.

The present invention has been made in view of the above problems, and an object of the present invention is to provide a method for forming an inorganic coating film which adheres well to a base material without using a binder component and can maintain excellent antimicrobial/antiviral/deodorizing performance for a long period of time.

According to another aspect of the present disclosure, it is an object to provide an inorganic coating liquid used in the method, an inorganic coating film formed by applying the inorganic coating liquid, and a device having the inorganic coating film.

### SUMMARY OF THE INVENTION

According to an aspect of the present invention, there is provided a method for forming an inorganic coating film, the method including: forming irregularities having a thickness of 0.1 to 1.0 μm on a base material corroded by an acid or a base material having a surface chemically and/or physically changed by an acid, using an inorganic coating liquid containing a copper ion and phosphoric acid and having a pH value of 2.0 to 6.0, in which the inorganic coating film includes copper and phosphorus derived from the copper ion and phosphoric acid.

In one embodiment, for the base material, a base material according to any one of (1) to (4) below is used:
(1) a metal base material containing one or more of copper, zinc, aluminum, zirconium, iron, nickel, chromium, molybdenum, or tungsten;
(2) an organic base material containing one or more of an acrylic resin, a polycarbonate resin, or an ABS resin;
(3) a base material containing a standard cotton fabric; and
(4) a base material containing polyethylene.

In one embodiment, the pH value of the inorganic coating liquid is preferably 3.0 to 5.0.

In one embodiment, the inorganic coating liquid may contain a copper ion and a phosphate ion derived from copper (II) phosphate.

In this case, copper (II) phosphate is used as a raw material of the inorganic coating liquid, and a solution obtained by dissolving the copper (II) phosphate can be used as the inorganic coating liquid. In this case, the inorganic coating liquid can also be referred to as a solution containing copper (II) phosphate in a molten state.

In one embodiment, the inorganic coating liquid may contain at least one of hydrochloric acid, nitric acid, sulfuric acid, hydrofluoric acid, a phosphate compound, a pyrophosphate compound, a chloride, a nitrate compound, a sulfate compound, a fluoride, an organic acid, an amino acid, a metal oxide, a hydroxide, or ammonia water.

In another embodiment, the present invention relates to an inorganic coating film produced by the above method. The inorganic coating film is a precipitate formed by drying and solidifying the inorganic coating liquid applied to the base material, and is formed on the irregularities of the base material.

In one embodiment, the inorganic coating liquid contains a metal oxide, and the metal oxide is contained in the irregularities formed on the base material.

In one embodiment, particulate solids each having a scale-like structure are precipitated on the irregularities formed on the base material.

In this embodiment, the particulate solids are preferably separated from each other.

In another embodiment, the present invention relates to a device having the inorganic coating film and exhibiting antimicrobial/antiviral performance.

According to the present invention, it is possible to provide a method for forming an inorganic coating film that is in close contact with a base material and maintains excellent antimicrobial/antiviral/deodorizing performance for a long period of time, by forming fine irregularities on a surface of the base material while controlling the pH using an inorganic coating liquid containing copper ions and phosphoric acid.

According to another aspect of the present invention, it is possible to provide a product exhibiting stable antimicrobial/antiviral performance over a long period of time by using an inorganic coating liquid, an inorganic coating film, and a device having an inorganic coating film.

### BRIEF DESCRIPTION OF THE DRAWINGS

FIG. 1 is a SEM image of an inorganic coating film, (a) of FIG. 1 is an enlarged image magnified 100 times, (b) is an enlarged image magnified 5000 times, and (c) is an enlarged image magnified 10,000 times;

FIG. 2 shows constituent element images of FIG. 1(b) and precipitates obtained by SEM-EDX of FIG. 1(b), and the magnification is 5000 times as in FIG. 1(b);

FIG. 3 is an optical photograph of SUS304 after a liquid used in Example 1 is applied onto SUS304 and a precipitate is polished, and black parts in the photograph are corroded parts;

FIG. 4 is a schematic view of particles and a substrate of an inorganic coating film;

FIG. 5 shows an image observed with transmission electron microscopy (TEM) and analytical images observed with scanning transmission electron microscopy with energy dispersive X-ray spectroscopy (STEM-EDS), after embedding a zirconium substrate obtained by applying the liquid used in Example 1 and drying the substrate for 20 days into a resin, and thinning the substrate using a focused ion beam scanning electron microscope (FIB-SEM) system, and (a) shows a precipitate on the zirconium substrate, (b) shows immediately below the surface of the zirconium substrate, and (c) shows the inside of the zirconium substrate;

FIG. 6 is a plane index of an electron diffraction pattern Cu₂P₂O₇ of “(a) precipitate on zirconium substrate” shown in FIG. 5;

FIG. 7 is a Cu2p, P2p, and Cl2p XPS spectra after the product precipitated on a SUS304 substrate is dried at room temperature; and

FIG. 8 shows SEM-EDS after precipitates on PMMA resin, SUS316L, and SUS304 substrates are dried for 8 days to 1 year, and a) was dried for 8 days, b) was dried for 2 months, c) was dried for 3 months, and d) was dried for 1 year.

### DETAILED DESCRIPTION

The present disclosure provides an inorganic coating liquid containing at least copper ions and phosphoric acid and having a pH value of 6.0 or less. The pH may preferably be in the range of 3.0 to 5.0. Furthermore, the inorganic coating liquid may contain at least one component selected from the group consisting of hydrochloric acid, nitric acid, sulfuric acid, hydrofluoric acid, a phosphate compound, a pyrophosphate compound, a chloride, a nitrate compound, a sulfate compound, a fluoride, an organic acid, an amino acid, a metal oxide, a hydroxide, or ammonia water.

In addition, by using the liquid of the present disclosure to corrode a part of the base material at the time of drying or chemically and/or physically change a surface thereof with an acid, the antimicrobial/antiviral component is bound to the base material, and the antimicrobial/antiviral performance can be maintained for a long period of time.

In addition, by forming scaly fine particles after drying the inorganic coating liquid, a specific surface area increases, a contact probability with bacteria, viruses, and the like increases, and the antimicrobial/antiviral performance can be further improved.

Usually, the color of a solution containing copper ions is blue. For example, in the case of copper sulfate, tetraamminecopper ions are formed. In addition, it has been found that when hydrochloric acid is added dropwise to a solution containing copper ions, blue-white precipitation occurs.

In order to impart antimicrobial properties, it is sufficient for a small amount of copper ions to be contained, and when the concentration of copper ions is low, the blue color of the solution containing copper ions becomes substantially transparent, and transparency can be secured when the solution is applied to any base material.

When the concentration of copper ions is low, the pH approaches almost neutral. When approaching neutral, the base material is not corroded, the smoothness of the base material is not lost, or an uneven surface is not formed on the base material. Therefore, when the solution applied to the base material is dried and solidified, the precipitate can be easily wiped off, and the antimicrobial/antiviral property cannot be maintained over a long period of time.

If the pH can be adjusted to corrode the base material to some extent, eliminate smoothness of the base material, or form an uneven surface on the base material, it is difficult to wipe off the precipitate easily even when the solution applied to the base material is dried and solidified. In particular, in the case of a metal base material, not only corrosion occurs, but also precipitated copper ions are firmly bonded to the base material, so that the precipitate cannot be easily wiped off.

However, when the pH is too low, corrosion to the base material and chemical and/or physical changes due to an acid on the surface of the base material become severe, the base material itself becomes brittle, the surface roughness also becomes worse, and the original strength and appearance of the base material deteriorate.

In addition to the simple antimicrobial property of copper ions, it is possible to further improve the antimicrobial performance by providing a fine structure that adsorbs bacteria and viruses.

The present disclosure includes an inorganic coating film comprising a corrosion layer on a coating film base material, wherein copper and phosphorus are included as components on the corrosion layer. In this case, the corrosion layer may be a chemically and/or physically changed base material. Preferably, the corrosion layer has irregularities and contains a metal oxide. Furthermore, the coating film base material preferably includes at least one metal material selected from copper, zinc, aluminum, zirconium, iron, nickel, chromium, molybdenum, and tungsten. Preferably, the thickness of the corrosion layer of the coated substrate is 1 μm or less. The coating film base material may also be an organic base material containing a resin and/or fiber. In this case, the surface of the resin and/or fiber may be chemically and/or physically changed, and copper and phosphorus may be present as components on the changed surface. The inorganic coating film may further comprise particulate solids of which a surface has a scale-like structure. In this case, the particulate solids may be separated from each other.

The present disclosure further includes an inorganic coating film formed by drying the inorganic coating liquid. In addition, the present disclosure further includes a device that includes the inorganic coating film and exhibiting antimicrobial and antiviral performance.

According to the present disclosure, it is possible to provide a product exhibiting stable antimicrobial/antiviral performance over a long period of time by using an inorganic coating liquid, an inorganic coating film, and a device having an inorganic coating film.

An inorganic coating liquid according to an embodiment is an inorganic coating liquid which is applied to a base material and formed into a coating film on the base material through a drying process, and contains copper ions and phosphoric acid. In addition, the inorganic coating liquid mainly has antimicrobial/antiviral/deodorizing performance.

A silver compound generally used as an antimicrobial material is prone to be altered to Ag₂O or the like by light irradiation, and blackening occurs when the amount of the silver compound reaches a certain amount or more, and in particular, in the case of a base material expected to have transparency, the appearance may be deteriorated. In addition, a platinum compound is expensive in terms of cost. For these reasons, use of copper ions is desirable.

A substance for pH adjustment contains phosphoric acid, and contains at least one of hydrochloric acid, nitric acid, sulfuric acid, hydrofluoric acid, a phosphate compound, a pyrophosphate compound, a chloride, a nitrate compound, a sulfate compound, a fluoride, an organic acid, an amino acid, a metal oxide, a hydroxide, or ammonia water. In particular, hydrochloric acid, a phosphate compound, a chloride, and an amino acid are effective for pH adjustment. Hydrochloric acid is inexpensive as an acid, there are many chlorides, and the degree of freedom in compound selection when reacting with copper is high. In addition, a phosphate compound can easily form a buffer solution in a weakly acidic region, and an amino acid has both an amino group and a carboxyl group, so that fine adjustment of pH in the weakly acidic region can be easily performed.

In a case where these compounds are used as pH adjusting agents, counter ions are required, and as the elements, at least one of sodium, magnesium, aluminum, potassium, calcium, silicon, titanium, vanadium, chromium, manganese, iron, cobalt, nickel, copper, zinc, gallium, germanium, rubidium, strontium, yttrium, zirconium, niobium, molybdenum, technetium, ruthenium, rhodium, palladium, silver, indium, tin, hafnium, tantalum, tungsten, rhenium, cesium, barium, platinum, or gold may be required.

The pH adjustment is necessary to partially corrode the base material during drying, eliminate the smoothness of the surface of the base material, or form an uneven surface on the base material, and an appropriate adjusting agent can be used for each base material.

Depending on the pH value, the degree of corrosion of the base material and the degree of chemical and/or physical change of the surface of the base material by the acid vary. When the pH is approximately 2.0 or less, the degree of corrosion of the base material increases. That is, the influence of a chemical change that causes a change in the surface of the base material due to a chemical reaction between the acid and the base material increases. Alternatively, the degree of occurrence of a physical change in which smoothness is impaired due to softening or the like of the surface of the base material by the coating liquid increases. These cause problems such as aesthetics and touch when using a device having an inorganic coating film. As described in Example 3 described later, the pH is preferably 2.0 to 6.0, and more preferably 3.0 to 5.0.

In the present invention, the inorganic coating liquid applied to a base material becomes an inorganic coating film after drying. A scaly fine particulate solid is formed in a part or the whole of the inorganic coating film. This solid increases a specific surface area, and in addition to exhibiting antimicrobial/antiviral effects, it can also be expected to provide deodorizing performance through physical adsorption of odor components in the fine gaps between the fine particles.

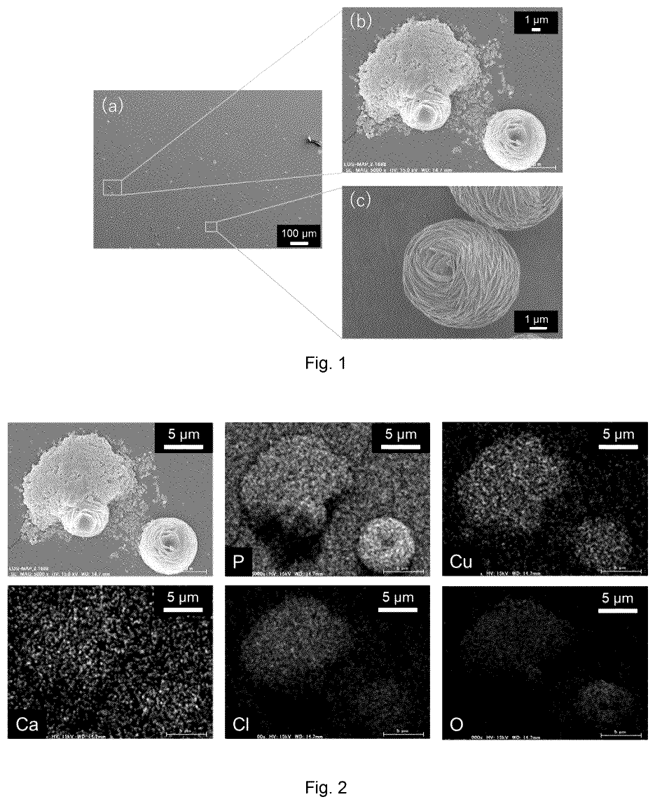

The results of SEM observation of the scaly fine particulate solid after drying in the present invention are shown in FIG. 1. A fine marimo-like shape formed by overlapping scaly structures is observed. The particulate solid is not a single component, and is an inorganic compound particle in which noble metal ions such as copper, and components such as chlorine, oxygen, and phosphorus are mixed.

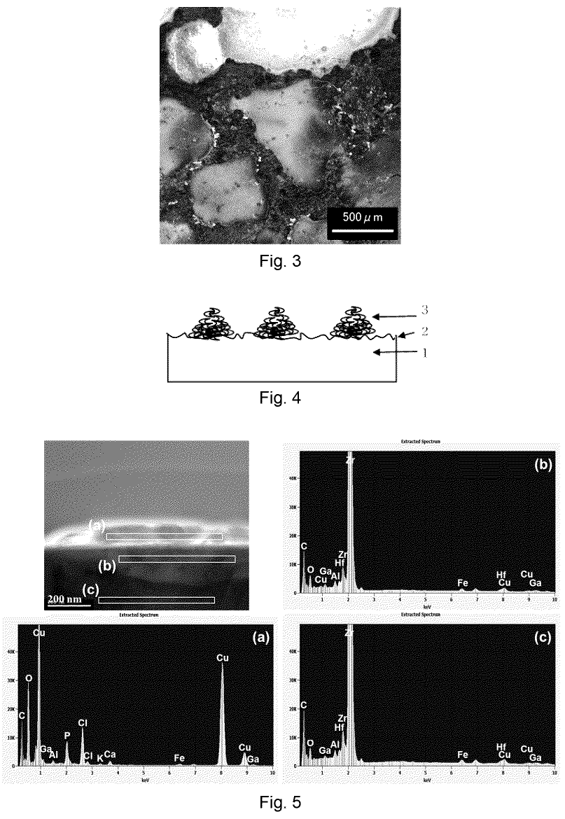

FIG. 2 shows optical photographs of SUS304 after an inorganic coating liquid is applied onto SUS304 and a precipitate is polished. A corrosion layer is shown below the precipitates. FIG. 4 is a schematic view of particles and a substrate of an inorganic coating film. 1 represents a base material, 2 represents an uneven surface due to corrosion, and 3 represents a precipitate particle (particulate solid). The precipitate particles are present separately from one another. After the inorganic coating liquid is applied, when the applied surface is dried, the precipitates aggregate at certain points due to surface tension to form nuclei, and crystal growth of the precipitates starts from the nuclei. Therefore, the solution on the coating surface around the nucleus is adsorbed to the nucleus, and the precipitate particles are present separately from one another because dissolved substances become sparse between the nuclei. In some rare cases, the nuclei are adjacent to each other, but are separated in most cases. Although varying with the base material, when the coating liquid of the present invention is applied, in the case of a metal base material, a corrosive action by an acid occurs, and in the case of plastics, smoothness of the surface of the base material is lost due to the acid, so that irregularities are formed on the surface of the base material. As a result, the base material and an inorganic compound are bonded to each other and are not easily peeled off. This is referred to as a strongly bonded scaly copper dispersion (SBSCD) structure.

The base material may be iron, a SUS material, or an organic base material such as an acrylic resin, a polycarbonate resin, or an ABS resin, and is not limited thereto.

The device coated with the inorganic coating film is expected to have stable antimicrobial/antiviral properties over a long period of time, and can be applied to household and business kitchen utensils, cooking devices, medical devices, and the like. Furthermore, the present invention can also be applied to fiber products such as polyester and cotton fabrics.

### EXAMPLES

Hereinafter, embodiments will be described more specifically with reference to examples.

### Example 1

Copper (II) phosphate was used as the inorganic compound. 1 Part by weight of the copper (II) phosphate was dissolved in 100 parts by weight of 0.1 M dilute hydrochloric acid. Further, 0.1 M sodium hydroxide, 0.1M phosphoric acid, and 0.1M aqueous ammonia were mixed to perform pH adjustment.

The pH of the liquid after pH adjustment was 3.0. A concentration of the inorganic compound was 0.15 wt %.

This solution was analyzed by inductively coupled plasma atomic emission spectroscopy (ICP-AES) to find that Cu²⁺=140 mg/L, Ca²⁺=0.11 mg/L, Cl⁻=33 mg/L, and HPO₄²⁻=12.0 mg/L.

This liquid was applied onto a PMMA resin and dried, and a surface of a film as a precipitate thereof was observed by SEM using SU-8000 manufactured by Hitachi, Ltd. The SEM photograph is shown in FIG. 1. In this photograph, scaly particles were scattered, and some particles that were not scaly were also observed. In addition, it was observed that there was a portion where the particles were separated in a spherical shape.

Analysis was performed by scanning electron microscopy energy dispersive X-ray spectroscopy (SEM-EDX), using an XPS manufactured by ULVAC with an Al-Kα ray as an X-ray source. The results are shown in FIG. 2. As shown in FIG. 2, the SEM-EDX is intended to identify constituent elements of precipitates having different shapes. These SEM-EDX analyses allow insight into a chemical composition and a mixing state of materials.

In addition, aggregates composed of particles of 10 μm or less indicated components such as Cu, Cl, and O, and flower-shaped precipitates contained components such as Cu, P, and O. The flower-shaped precipitate is similar to the SEM image of Cu₂(OH)PO₄ of Siyuan Yang, Kejia Xu, Hongjuan Wang, Hao Yu, Shanqing Zhang, Feng Peng, Solution growth of peony-like copper hydroxyl-phosphate (Cu₂(OH)PO₄) flowers on Cu foil and their photocatalytic activity under visible light, Materials & Design, Volume 100, 2016, Page 30-36. However, Cu₂(OH)PO₄ of Siyuan Yang, Kejia Xu, Hongjuan Wang, Hao Yu, Shanqing Zhang, Feng Peng, Solution growth of peony-like copper hydroxyl-phosphate (Cu₂(OH)PO₄) flowers on Cu foil and their photocatalytic activity under visible light, Materials & Design, Volume 100, 2016, Page 30-36 has anisotropic crosslinked petals and a peony shape, has a size of several tens of μm, and is different in size and fine shape from Cu₂(OH)PO₄ of the present invention.

In this example, a PMMA resin was used, but a similar film was formed even with an ABS resin or a standard cotton fabric.

### Example 2

A liquid similar to that in Example 1 was applied onto a SUS304 substrate and dried for 24 hours, and then particles on a surface of a film which are precipitates of the liquid were scaly particles similar to those in Example 1. An optical photograph obtained by polishing the film is shown in FIG. 3.

As described above, it was confirmed that the base material was corroded even after polishing. As a result of polishing and scraping the base material until the corroded part disappeared, the corroded surface of the base material was 0.6 μm. FIG. 4 shows a schematic view of particles of the inorganic coating film and a substrate.

### Example 3

An inorganic coating liquid was applied to a SUS304 plate in the same manner as in Example 2 except that the pH value was changed to 1, 2, 4, 5, 6, or 7, and the presence or absence of the appearance of the scaly compound and the thickness of the corrosion layer were confirmed. In addition, a peeling test was performed by a cross-cut method according to JIS K5600-5-6. The results including the results under conditions (pH value of 3) of Example 2 are shown in Table 1.

TABLE 1

| pH | Scaly | Corrosion | Number of peelings by cross-cut |
|---|---|---|---|
| value | compound | thickness | test according to JIS K5600-5-6 |
| 1 | Not observed | 2.0 μm | 0/25 |
| 2 | Slightly present | 1.0 μm | 0/25 |
| 3 | Present | 0.6 μm | 0/25 |
| 4 | Present | 0.4 μm | 0/25 |
| 5 | Present | 0.2 μm | 0/25 |
| 6 | Slightly present | 0.1 μm | 5/25 |
| 7 | Not observed | 0.0 μm | 20/25 |

A scaly compound was observed at a pH value of 2 or more and 6 or less. In addition, in a case where the pH value was 2 or less, the thickness of the corrosion layer exceeded 1 μm, and the appearance was also in an unpreferable state. Furthermore, in a case where the pH value was 7, peeling was severe, and a phenomenon that peeling did not occur was observed at the pH value of 5 or less. From these facts, it can be said that the pH value is preferably 2 or more and 6 or less. More preferably, the pH value is 3 or more and 5 or less, and the scaly compound and moderate corrosiveness are both observed, which is a good state.

From these facts, it is considered that a similar effect is exhibited as long as a metal corroded by an acid, that is, copper, zinc, aluminum, zirconium, and iron, nickel, chromium, molybdenum, and tungsten which are used for SUS materials are contained in the base material.

### Example 4

A liquid prepared in the same manner as in Example 1 was applied onto a zirconium substrate. For cross-sectional observation, a zirconium substrate obtained by applying the liquid of Example 1 and drying the substrate for 20 days was embedded in a resin, thinned using a focused ion beam scanning electron microscope (FIB-SEM) system, and then confirmed by a transmission electron microscope (TEM). The results are shown in FIG. 5.

(a) shows the precipitates on a zirconium substrate, (b) shows the region just below the surface of the substrate, and (c) shows the inside of the zirconium substrate, based on the results of scanning transmission electron microscope energy dispersive X-ray spectroscopy (STEM-EDS) analysis. Although not clear as in the schematic view of FIG. 4, the uneven surface can be seen on an upper surface of the substrate. In the precipitates, elements such as Cu, P, Cl, and O, which were not present in the zirconium substrate, were detected. From these results, it is presumed that the precipitates of both the PMMA resin substrate and the zirconium substrate share the same composition of Cu, P, Cl, and O.

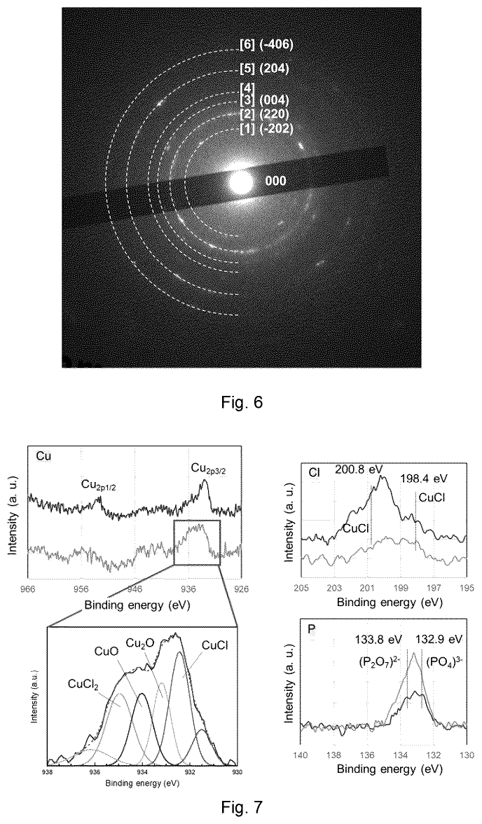

FIG. 6 shows an electron diffraction pattern of the precipitate (a) shown in FIG. 5. A crystal structure of the precipitate was identified to be various copper compounds such as Cu₂P₂O₇, Cu₂O, and Cl₂Cu₂O. It is presumed that these copper compounds were formed by dissolving and precipitating ions present in the inorganic coating liquid. It is found that the diffraction pattern is not clear because the number of microcrystals in the precipitate is small and the crystallinity is low. Among them, many diffraction patterns were coincident with Cu₂P₂O₇, and were the (−202) plane of [1], the (220) plane of [2], the (004) plane of [3], the (204) plane of [5], and the (−406) plane of [6].

The diffraction patterns of [2] and [3] were identical to the diffraction patterns of Cu₂O and Cl₂Cu₂O. [2] was also present on the (211) plane of Cu₂O and the (222) plane of Cl₂Cu₂O, and [3] was also present on the (220) plane of Cu₂O and the (331) plane of Cl₂Cu₂O. Further, [4] coincided with the (133) plane of Cl₂Cu₂O, and [6] coincided with the (332) plane of Cu₂O.

There were three crystals consistent with the obtained electron diffraction pattern, suggesting that the precipitate was a mixture of Cu₂P₂O₇, Cu₂O, and Cl₂Cu₂O.

### Example 5

A standard cotton fabric of 5 cm×5 cm was sprayed with 1 mL of the same liquid as in Example 1 and dried in a safety cabinet for 24 hours. Thereafter, various antimicrobial properties were confirmed by a film adhesion method. The results are shown in Table 2.

TABLE 2

| | Antibacterial | |
|---|---|---|
| | activity value | Below |
| | (ISO 20743: | detection |
| Bacteria | 2013 applied) | limit |
| E. coli NBRC 3301 | 6.2 | Yes |
| E. coli O-157 RIMD 0509952 | 4.7 | No |
| S. aureus NBRC 12732 | 5.9 | No |
| Methicillin-resistant S. aureus IID 1677 | 5.8 | Yes |
| P. aeruginosa NBRC 3080 | 6.0 | Yes |
| M. osloensis ATCC 19976 | 6.3 | Yes |
| K. pneumoniae NBRC 13277 | 6.1 | Yes |
| S. enterica subsp. enterica NBRC 3313 | 3.3 | Yes |

The antimicrobial activity value refers to the common logarithm×(−1) of the ratio of the number of bacteria in the sample treated with an antimicrobial agent to the number of bacteria in the comparative control. For example, in a case where the number of bacteria in the control is 10,000 and the number of bacteria in the sample is 100, that is, in a case where the number of bacteria relative to the control is 1/100, −log(100/10000)=2.0 is obtained. In the case of the present invention, as shown in Table 2, the antimicrobial activity values of all the tested bacteria were 3.0 or more (that is, the number of bacteria relative to the control is 1/1000 or less), and excellent antimicrobial activity values were shown.

In addition, a polyethylene film of 5 cm×5 cm was similarly sprayed and dried in a safety cabinet for 24 hours. Thereafter, various antiviral properties were confirmed by a film adhesion method. The results are shown in Table 3.

TABLE 3

| | Antiviral | |
|---|---|---|
| | activity value | |
| | (ISO 21702 | Contact |
| Virus | applied) | time |
| Influenza A/H3N2 A/Hong Kong/8/68: TC- | 5.0 | 15 min |
| adapted ATCC VR-1679 | | |
| Feline calicivirus, strain F-9 ATCC VR-782 | 3.1 | 15 min |
| SARS-CoV-2 NIID isolate JPN/TY/WK-52 | 3.1 | 30 min |
| SARS-CoV-2 variant (Alpha) hCoV- | 3 | 30 min |
| 19/Japan/QK002/2020 | | |
| SARS-CoV-2 variant (Delta) hCoV- | 4.3 | 30 min |
| 19/Japan/TY11-927-P1/2021 | | |
| SARS-CoV-2 variant (Omicron) hCoV- | 4.9 | 60 min |
| 19/Japan/TY38-873/2021 | | |

The same calculation method was used for the antiviral activity value as well as the antimicrobial activity value, and the antiviral activity value was 3.0 or more in all the tested viruses, indicating an excellent antiviral activity value.

### Example 6

SUS304 and PMMA resin samples prepared in the same manner as in Example 1 and Example 3 were dried at normal temperature for 2 weeks, 3 months, 6 months, and 1 year, and the antimicrobial activity values against E. coli and S. aureus were confirmed in accordance with JIS Z2801. The results are shown in Table 4.

TABLE 4

| Bacterial | Base | After 2 | After 3 | After 6 | After 1 |
|---|---|---|---|---|---|
| species | material | weeks | months | months | year |
| E. coli | SUS304 | 2.0 | 2.1 | 3.3 | 1.8 |
| NBRC3301 | PMMA resin | 3.5 | 2.2 | 3.3 | 2.1 |
| S. aureus | SUS304 | 3.5 | 4.1 | 4.0 | 1.1 |
| NBRC12732 | PMMA resin | 3.6 | 3.2 | 4.1 | 1.4 |

As shown in Table 4, the antimicrobial activity value was as good as 2 or more until 6 months. After 1 year, the antimicrobial activity value decreased.

In addition, Cu2p, P2p, and Cl2p spectra of precipitates on the SUS304 substrate of samples prepared in the same manner on day 8 and after 1 year were confirmed. The results are shown in FIG. 7. Both the samples dried for 8 days and 1 year had spectra of copper, chlorine, and phosphorus. In the case of the Cu2P3/2 level of the sample dried for 8 days, the binding energies of CuCl, CuCl₂, Cu₂O and CuO were 933.2, 935.1, 932.8 and 933.6 eV, respectively. The percentages of CuCl, CuCl₂, Cu₂O and CuO determined from the deconvoluted spectra were 26.9, 18.2, 17.4 and 22.4 area %, respectively.

The presence of Cl in the precipitated product was characterized using XPS, and the major Cu—Cl bonds in CuCl were located at 198.4 eV and 200.8 eV, respectively, as shown in the Cl spectrum in FIG. 7. The presence of P in the precipitated product was characterized using XPS, and PO₄³⁻ and P₂O₇²⁻ were located at 132.9 eV and 133.8 eV, respectively.

Thus, chlorine and phosphorus are incorporated into CuO during the drying process, which is consistent with the EDS results in FIG. 6. Also, the components of the sample dried for 1 year were consistent with those of the sample dried for 8 days. However, a proportion of the Cu compound in the sample dried for 1 year changed. The amount of chlorine tended to increase and the amount of phosphorus tended to decrease in the sample dried for 1 year changed compared to the sample dried for 8 days.

Atom % values of O1s, P2p, Cl2p, and Cu2p from deconvoluted spectra are shown in Table 5.

TABLE 5
Elements (atom %)

| Drying | SUS304 | | | | SUS316L | | | |
|---|---|---|---|---|---|---|---|---|
| time | O₁ₛ | P₂ₚ | Cl₂ₚ | Cu₂ₚ | O₁ₛ | P₂ₚ | Cl₂ₚ | Cu₂ₚ |
| 8 days | 90.1 | 7.1 | 1.7 | 1.1 | 95.2 | 3.4 | 0.2 | 1.2 |
| 3 months | 92.4 | 5.2 | 0.2 | 2.2 | 93.2 | 3.3 | 2.1 | 2.1 |
| 6 months | 92.4 | 1.4 | 1.3 | 4.9 | 92.9 | 0.8 | 1.4 | 3 |
| 1 year | 95.8 | 1.7 | 2.2 | 0.3 | 93.2 | 2.3 | 2.6 | 1.9 |

XPS measurements of precipitates on PMMA resin were difficult to obtain data due to charge accumulation. A 0.8 mm diameter region on the substrate was evaluated using XPS. In this region, the precipitates are scattered with a diameter of 5 mm. Therefore, a substrate component and a large amount of oxygen are present in a region outside the precipitate. On all substrates, the amount of P2p decreased and the amount of Cl2p increased with drying.

Meanwhile, the content of Cu increased up to 6 months after drying and then decreased. On a coated surface with the inorganic coating liquid of the present invention, Cu₂P₂O₇, Cu₂O and Cl₂Cu₂O are precipitated together by a dissolution deposition mechanism. At the beginning of the compound precipitation, the crystallinity of the precipitate was low, and it was expected that the crystal would grow as it dried.

Crystallization was expected to continue for up to 6 months of drying, after which Cu₂p was reduced due to the consumption of larger growth planes. Since XPS measurement of the PMMA resin was difficult, temporal changes of SBSCD on various substrates were also examined by SEM-EDX.

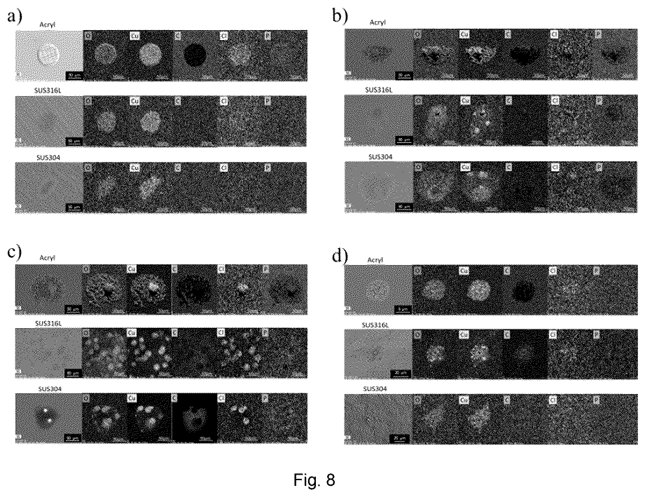

FIG. 8 shows SEM-EDS after SBSCD on PMMA resin, SUS316L, and SUS304 substrates are dried for 8 days to 1 year. After drying for 8 days, components such as Cu, Cl, P, and O on the PMMA resin substrate could be confirmed similarly to SUS304 and SUS316L. Even when the drying time was long, there was no difference in the composition of the precipitate between different types of substrates.

Therefore, the substrate-type dependence of antimicrobial property is considered to be related to the number of crystallites and crystallinity, rather than the type of precipitates. Cu ions are involved in antimicrobial properties, and it is considered that the elution behavior of Cu ions varies depending on crystallinity.

### Example 7

The same liquid as in Example 1 was applied to a SUS preparation table, a steam convection oven handle, a worktable above dishwasher, and a metal toilet door handle of a restaurant, and dried at room temperature for 48 hours. ATP values at the same place before application and after application and drying were measured by an ATP wiping test method using a Lumitester and a Lucipac pen manufactured by Kikkoman Biochemifa Corporation which are commonly used in food processing plants and dental clinics.

The ATP value is an alternative method for evaluating microbial contamination, and is a method for measuring the amount of adenosine triphosphate (ATP) that living organisms have as an energy source. The ATP value is contained in microorganisms such as bacteria, and when there are many bacteria at the measurement site, the ATP value increases, and when there are few bacteria, the ATP value decreases. In the ATP wiping test method, the measurement can be performed in several tens of seconds for each place. Therefore, in the case of the evaluation at the same place, the ATP value relatively changes depending on the magnitude of the number of bacteria, so that the hygiene situation of the control site can be easily checked as compared with the conventional antimicrobial test. The results of the ATP values are shown in Table 6.

TABLE 6

| | Before | After application |
|---|---|---|
| Measuring site | application | and drying |
| Cooking table | 7933 | 2574 |
| Steam-convection oven handle | 1052 | 523 |
| Worktable above dishwasher | 6301 | 370 |
| Toilet door handle (metal) | 9157 | 778 |

Table 6 shows that the inorganic coating liquid of Example 1 was applied to all the measurement sites, and the ATP value decreased after drying.

Although the food processing field has been described in the present examples, the present invention can be widely applied to fields in which antimicrobial properties are required, such as medical care, nursing care, and pediatric facilities.

As described above, in the present invention, the inorganic coating liquid containing a copper ion and phosphoric acid and having a pH value of 6.0 or less has achieved an antimicrobial film which has a strong binding force to a coating film base material, is scaly, and can achieve both high durability and antimicrobial properties. This antimicrobial film can be applied to a wide range of fields because high functionality is realized by simple liquid adjustment and coating without using an expensive material, and the industrial value thereof is extremely high.

What is claimed is:

1. A method for forming an inorganic coating film, the method comprising:
forming irregularities having a thickness of 0.1 to 1.0 μm on a base material corroded by an acid or a base material having a surface chemically and/or physically changed by an acid, using an inorganic coating liquid containing a copper ion and phosphoric acid and having a pH value of 2.0 to 6.0,
wherein the inorganic coating film includes copper and phosphorus derived from the copper ion and phosphoric acid.

2. The method according to claim 1, wherein the base material is a base material according to any one of (1) to (4) below:
(1) a metal base material containing one or more of copper, zinc, aluminum, zirconium, iron, nickel, chromium, molybdenum, or tungsten;
(2) an organic base material containing one or more of an acrylic resin, a polycarbonate resin, or an ABS resin;
(3) a base material containing a standard cotton fabric; and
(4) a base material containing polyethylene.

3. The method for forming an inorganic coating film according to claim 1, wherein the pH value of the inorganic coating liquid is 3.0 to 5.0.

4. The method according to claim 1, wherein the inorganic coating liquid contains a copper ion and a phosphate ion derived from copper (II) phosphate.

5. The method for forming an inorganic coating film according to claim 1, wherein the inorganic coating liquid contains at least one of hydrochloric acid, nitric acid, sulfuric acid, hydrofluoric acid, a phosphate compound, a pyrophosphate compound, a chloride, a nitrate compound, a sulfate compound, a fluoride, an organic acid, an amino acid, a metal oxide, a hydroxide, or ammonia water.

6. An inorganic coating film produced by the method according to claim 1, which is a precipitate formed by drying and solidifying the inorganic coating liquid applied to the base material, and is formed on the irregularities of the base material.

7. The inorganic coating film according to claim 6, wherein the inorganic coating liquid contains a metal oxide, and the metal oxide is contained in the irregularities formed on the base material.

8. The inorganic coating film according to claim 6, wherein particulate solids each having a scale-like structure are precipitated on the irregularities formed on the base material.

9. The inorganic coating film according to claim 8, wherein the particulate solids are separated from each other.

10. A device comprising the inorganic coating film according to claim 6, which exhibits antimicrobial/antiviral performance.
